(19) United States
(12) Patent Application Publication
(10) Pub. No.: US 2026/0104561 A1
(43) Pub. Date: Apr. 16, 2026

(54) OPTICAL MODULE AND INFORMATION DEVICE

(71) Applicant: SUMITOMO ELECTRIC INDUSTRIES, LTD., Osaka-shi (JP)

(72) Inventors: Masaki SUZUKI, Osaka (JP); Takeshi INOUE, Osaka (JP); Yasunori ASANO, Osaka (JP); Shun ENDO, Osaka (JP)

(73) Assignee: SUMITOMO ELECTRIC INDUSTRIES, LTD., Osaka-shi (JP)

(21) Appl. No.: 19/347,116

(22) Filed: Oct. 1, 2025

(30) Foreign Application Priority Data
Oct. 10, 2024 (JP) 2024-177700

(51) Int. Cl. G02B 6/42

(52) U.S. Cl. CPC G02B 6/4239; G02B 6/4214; G02B 6/4257

(57) ABSTRACT

An optical module includes a substrate including a main surface, an optical element disposed on the main surface, a lens component disposed on the main surface, an optical fiber including a tip portion and a covered portion continuous from the tip portion, a covering member that covers the covered portion such that the tip portion is exposed, an auxiliary member, and an adhesive portion. The lens component includes an optical fiber holding portion that holds the tip portion, and a lens portion disposed on an optical path between the optical element and the tip portion of the optical fiber. The auxiliary member is disposed relative to the optical fiber holding portion in a first direction, the first direction extending from the tip portion of the optical fiber toward the covered portion of the optical fiber. The adhesive portion bonds the covering member and the auxiliary member.

### CROSS-REFERENCE TO RELATED APPLICATION

This application claims priority based on Japanese Patent Application No. 2024-177700 filed on October 10, 2024, and the entire contents of the Japanese patent application are incorporated herein by reference.

### TECHNICAL FIELD

The present disclosure relates to an optical module and an information device.

### BACKGROUND

Patent Literature 1 discloses a notebook computer having a hinge mechanism. The notebook computer includes a first housing containing a circuit board, a hard disk drive, and the like, and a second housing containing a liquid crystal display. Patent Literature 2 discloses an electronic device including an electronic device body, a rotating device rotatably attached by a hinge mechanism, and an electric wire connecting the electronic device body and the rotating device. Patent Literature 3 discloses a tape recorder/editor having an electronic device body and a rotating device which is a display unit rotating with respect to the electronic device body.

Patent literature 1: Japanese Unexamined Patent Application Publication No. 2011-119698

Patent literature 2: Japanese Unexamined Patent Application Publication No. 6-131077

Patent literature 3: Japanese Unexamined Patent Application Publication No. 2001-154760

Patent literature 4: Japanese Unexamined Patent Application Publication No. 2019-82508

Patent literature 5: WO 2023/013348

### SUMMARY

An optical module according to an embodiment of the present disclosure includes a substrate including a main surface, an optical element disposed on the main surface, a lens component disposed on the main surface, an optical fiber including a tip portion and a covered portion continuous from the tip portion, a covering member that covers the covered portion such that the tip portion is exposed, an auxiliary member, and an adhesive portion. The lens component includes an optical fiber holding portion that holds the tip portion, and a lens portion disposed on an optical path between the optical element and the tip portion of the optical fiber. The auxiliary member is disposed relative to the optical fiber holding portion in a first direction, the first direction extending from the tip portion of the optical fiber toward the covered portion of the optical fiber. The adhesive portion bonds the covering member and the auxiliary member to each other.

### BRIEF DESCRIPTION OF THE DRAWINGS

FIG. 1 is a perspective view showing an information device according to a first embodiment.

FIG. 2 is a top view showing an optical module included in the information device shown in FIG. 1.

FIG. 3 is a top view showing a part of the optical module shown in FIG. 2 in an enlarged manner.

FIG. 4 is a cross-sectional view taken along line IV-IV of FIG. 3.

FIG. 5 is a top view showing a part of an optical module according to a modification of a first embodiment in an enlarged manner.

FIG. 6 is a top view showing a part of an optical module according to a second embodiment in an enlarged manner.

FIG. 7 is a cross-sectional view taken along line VII-VII of FIG. 6.

FIG. 8 is a perspective view showing an information device according to a third embodiment.

FIG. 9 is a top view showing a part of an optical module included in the information device shown in FIG. 8 in an enlarged manner.

FIG. 10 is a cross-sectional view taken along line X-X of FIG. 9.

FIG. 11 is a cross-sectional view showing a state in which a through hole of a fixing portion is filled with an adhesive portion.

FIG. 12 is a top view showing a part of an optical module included in an information device according to a fourth embodiment in an enlarged manner.

### DETAILED DESCRIPTION

In an information device, the transmission capacity of signals is increasing due to reasons such as improvement in the performance of a electrical device incorporated in the information device. It is assumed that the number of electrical devices mounted in the information device increases. With the increase in the transmission capacity of signals and the increase in the number of electrical devices mounted in the information device, there is a possibility that an electric wire needs to be thickened or the number of electric wires needs to be increased.

In order to reduce an area occupied by a wiring in the information device, it is conceivable to use an optical module having an optical fiber capable of transmitting a large amount of signals. In this case, the optical module needs to be downsized in order to be incorporated in the information device. When a lens component that holds a tip portion of the optical fiber is downsized with downsizing of the optical module, a portion of the lens component that holds the tip portion of the optical fiber is also downsized. In this case, influence of an external force acting on the optical fiber on the tip portion of the optical fiber may increase.

An object of the present disclosure is to provide an optical module and an information device that can improve reliability of an optical fiber.

First, the contents of the embodiments of the present disclosure will be listed and described.

[1] An optical module according to one embodiment includes a substrate including a main surface, an optical element disposed on the main surface, a lens component disposed on the main surface, an optical fiber including a tip portion and a covered portion continuous from the tip portion, a covering member that covers the covered portion such that the tip portion is exposed, an auxiliary member, and an adhesive portion. The lens component includes an optical fiber holding portion that holds the tip portion, and a lens portion disposed on an optical path between the optical element and the tip portion of the optical fiber. The auxiliary member is disposed relative to the optical fiber holding portion in a first direction, the first direction extending from the tip portion of the optical fiber toward the covered portion of the optical fiber. The adhesive portion bonds the covering member and the auxiliary member to each other.

In this optical module, the covering member covering the optical fiber is bonded to the auxiliary member disposed relative to the optical fiber holding portion in the first direction extending from the tip portion of the optical fiber to the covered portion by the adhesive portion. In this manner, the covering member is bonded to the auxiliary member in front of the tip portion of the optical fiber, so that the influence of an external force (for example, an external force such as bending, twisting, or pulling of the optical fiber) acting on the optical fiber on the tip portion of the optical fiber can be reduced. This can prevent, for example, damage or the like to the tip portion of the optical fiber due to the external force acting on the optical fiber. Thus, according to the optical module, reliability of the optical fiber can be improved.

[2] In the optical module according to the above [1], the adhesive portion may bond the tip portion and the optical fiber holding portion to each other and may extend from the optical fiber holding portion toward the auxiliary member. In this case, the tip portion of the optical fiber can be fixed to the optical fiber holding portion, and the covering member can be fixed to the auxiliary member. Thus, the optical fiber can be stably fixed.

[3] In the optical module according to the above [1] or [2], the auxiliary member may be disposed between the covering member and the main surface and may be fixed to the main surface. In this case, the auxiliary member can support the covering member, and the optical fiber can be stably fixed.

[4] In the optical module according to the above [3], the auxiliary member may include a corner portion located opposite to the optical fiber holding portion, the corner portion and the covering member facing each other. The corner portion may be chamfered. For example, when the external force such as bending of the optical fiber occurs, the covering member covering the covered portion of the optical fiber follows the chamfered corner portion, so that the influence on the tip portion of the optical fiber (stress transmitted to the tip portion) can be further reduced. Thus, the reliability of the optical fiber can be further improved.

[5] In the optical module according to the above [3] or [4], when viewed from a second direction intersecting the main surface, the auxiliary member may be formed such that a width of the auxiliary member decreases with increasing distance from the optical fiber holding portion in the first direction. In this case, a portion of the auxiliary member having a small width (a portion relatively distant from the tip portion of the optical fiber) becomes soft. Thus, for example, when the external force such as bending of the optical fiber occurs, the portion having a small width is easily deformed, and as a result, the influence on the tip portion of the optical fiber can be further reduced. Thus, the reliability of the optical fiber can be further improved.

[6] In the optical module according to any one of the above [3] to [5], a Young's modulus of the auxiliary member may be smaller than a Young's modulus of the optical fiber. In this case, the auxiliary member becomes relatively soft. As a result, for example, when the external force such as bending of the optical fiber occurs, the auxiliary member absorbs the external force, and thus the influence on the tip portion of the optical fiber (stress transmitted to the tip portion) can be further reduced.

[7] In the optical module according to any one of the above [1] to [6], the auxiliary member may be disposed alongside the covering member in a third direction, the third direction intersecting the first direction and extending along the main surface. The auxiliary member is disposed alongside the covering member in the third direction, thereby effectively preventing the optical fiber from being bent in the third direction.

[8] In the optical module according to the above [7], the auxiliary member may include a dummy optical fiber configured not to transmit light and a dummy covering member that covers the dummy optical fiber. A tip portion of the dummy optical fiber may be held by the optical fiber holding portion. The adhesive portion may bonds the covering member and the dummy covering member to each other. In this case, a bonding area of the covering member can be increased while the dummy optical fiber and the dummy covering member are disposed using the optical fiber holding portion.

[9] In the optical module according to any one of the above [1] to [8], the auxiliary member may include a first auxiliary member disposed between the covering member and the main surface and fixed to the main surface, and a second auxiliary member disposed alongside the covering member in a third direction, the third direction intersecting the first direction and extending along the main surface. The adhesive portion may bonds the covering member and the first auxiliary member to each other and bonds the covering member and the second auxiliary member to each other. In this case, the bonding area of the covering member can be increased, and the optical fiber can be more stably fixed. Thus, the influence on the tip portion of the optical fiber can be further reduced, and as a result, the reliability of the optical fiber can be further improved.

An information device according to one embodiment may include the optical module according to any one of the above [1] to [9], and a housing that houses the optical module. In this case, the information device can transmit light using the optical module.

An information device according to one embodiment includes an optical module, a fixing portion, and a housing that houses the optical module and the fixing portion. The optical module includes a substrate including a main surface, an optical element disposed on the main surface, a lens component disposed on the main surface, and at least one optical fiber including a tip portion and a covered portion continuous from the tip portion. The lens component includes an optical fiber holding portion that holds the tip portion, and a lens portion disposed on an optical path between the optical element and the tip portion of the optical fiber. The fixing portion is fixed to the housing relative to the substrate in a first direction, the first direction extending from the tip portion of the optical fiber toward the covered portion of the optical fiber, and holds the optical fiber.

In this information device, the optical fiber is held by the fixing portion fixed to the housing relative to the substrate in the first direction extending from the tip portion of the optical fiber toward the covered portion. In this manner, the optical fiber is held by the fixing portion in front of the tip portion of the optical fiber, so that the influence of an external force (for example, an external force such as bending of the optical fiber) acting on the optical fiber on the tip portion of the optical fiber can be reduced. This can prevent, for example, damage or the like to the tip portion of the optical fiber due to the external force acting on the optical fiber. Thus, according to the information device, the reliability of the optical fiber can be improved.

In the information device according to the above , the fixing portion may have a through hole into which the at least one optical fiber or a plurality of the optical fibers is inserted. The through hole may have an edge portion open opposite to the substrate. The edge portion may be curved in a convex manner such that a width of the through hole increases. For example, when the external force such as bending of the optical fiber occurs, the optical fiber follows the edge portion, so that the influence on the tip portion of the optical fiber (stress transmitted to the tip portion) can be further reduced.

The information device according to the above or may further include an elastic member. The fixing portion may have a through hole into which the at least one optical fiber is inserted. The elastic member may be disposed between the optical fiber and the through hole. For example, when the external force such as bending of the optical fiber occurs, the elastic member absorbs the external force, so that the influence on the tip portion of the optical fiber (stress transmitted to the tip portion) can be further reduced.

The information device according to any one of the above to may further include a first adhesive portion and a second adhesive portion. The optical module may further include a covering member that covers the covered portion such that the tip portion is exposed. The first adhesive portion may bond the tip portion and the optical fiber holding portion to each other. The second adhesive portion may bond the fixing portion and the covering member to each other. A bonding strength between the fixing portion and the covering member may be greater than a bonding strength between the tip portion and the optical fiber holding portion. In this case, the tensile strength of the optical fiber can be improved.

In the information device according to any one of the above to , the optical module may further include a covering member that covers the covered portion such that the tip portion is exposed, an auxiliary member, and an adhesive portion. The auxiliary member may include at least one of a first auxiliary member disposed between the covering member and the main surface and fixed to the main surface, and a second auxiliary member disposed alongside the covering member in a third direction, the third direction intersecting the first direction and extending along the main surface. The adhesive portion may bond the covering member and at least one of the first auxiliary member and the second auxiliary member to each other. In this manner, the optical fiber can be more stably fixed by increasing the bonding area of the covering member by the auxiliary member and further holding the optical fiber by the fixing portion. Thus, when the external force such as bending of the optical fiber occurs, the influence on the tip portion of the optical fiber (stress transmitted to the tip portion) can be further reduced.

Specific examples of an optical module and an information device according to an embodiment of the present disclosure will be described below with reference to the drawings. In the following description, the same reference numerals are used for the same elements or elements having the same functions, and redundant description will be omitted. The present invention is not limited to these examples, but is defined by the scope of the claims, and is intended to include all modifications within the meaning and scope equivalent to the scope of the claims.

### First embodiment

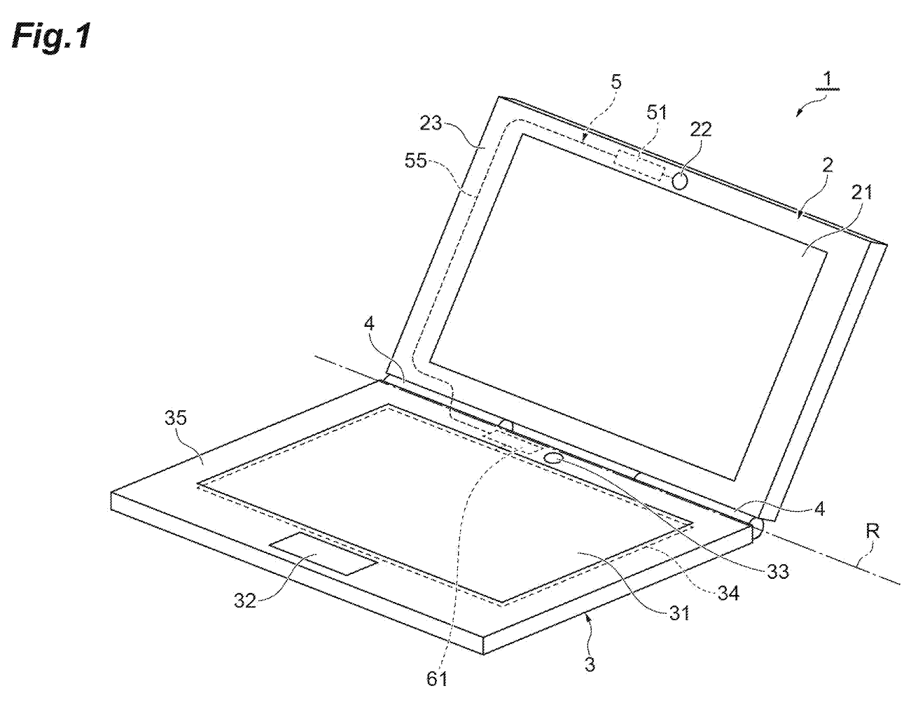

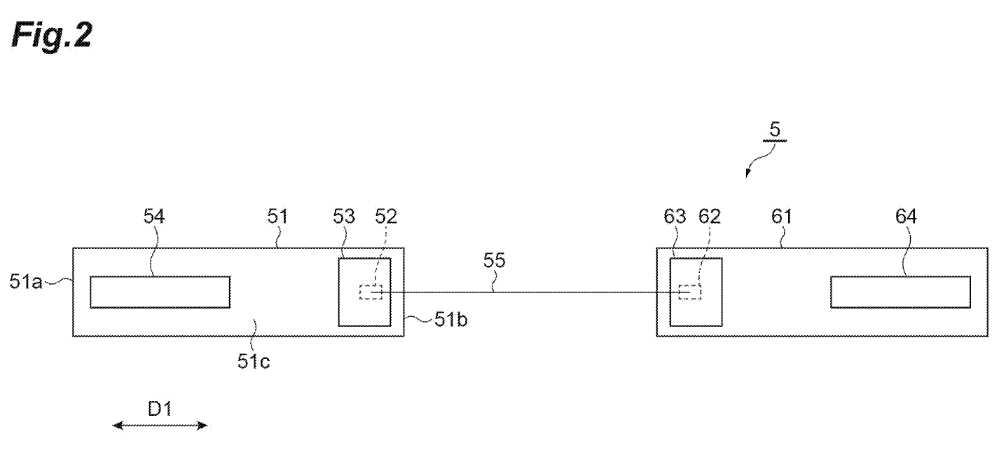

FIG. 1 is a perspective view showing an example of an information device according to a first embodiment. FIG. 2 is a view showing an optical module included in the information device shown in FIG. 1. An information device 1 includes a monitor unit 2, a main body portion 3, and a hinge portion 4. In the embodiment, the information device 1 is a notebook computer. The monitor unit 2 and the main body portion 3 are connected to each other via the hinge portion 4. The hinge portion 4 is a portion that allows the monitor unit 2 to be rotatable with respect to the main body portion 3 around a rotation axis R.

The monitor unit 2 includes a display 21, a camera 22, and a housing 23. The display 21 is, for example, a liquid crystal display, and the camera 22 is, for example, a Web camera. The display 21 and the camera 22 are driven by receiving electric signals. The housing 23 is formed in a flat rectangular parallelepiped shape. The housing 23 holds the display 21 and the camera 22.

The main body portion 3 includes a keyboard 31, a touch pad 32, a power button 33, a motherboard 34, and a housing 35. Each of the keyboard 31, the touch pad 32, and the power button 33 is electrically connected to the motherboard 34. The keyboard 31, the touch pad 32, and the power button 33 are portions operated by a user of the information device 1. When each of the keyboard 31, the touch pad 32, and the power button 33 is operated, signals are output from the motherboard 34 to each unit of the information device 1, and each unit of the information device 1 functions. The housing 35 is formed in a flat rectangular parallelepiped shape. The housing 35 holds the keyboard 31, the touch pad 32, and the power button 33.

The information device 1 further includes an optical module 5. The optical module 5 is housed in a housing (in the embodiment, the housing 23 of the monitor unit 2 and the housing 35 of the main body portion 3) of the information device 1. The optical module 5 includes substrates 51 and 61, optical elements 52 and 62, lens components 53 and 63, electrical connectors 54 and 64, and an optical fiber 55. In the optical module 5 shown in FIG. 2, the optical fiber 55 extends straight along a direction D1. The optical element 52, the lens component 53, and the electrical connector 54 are mounted on the substrate 51. The optical element 62, the lens component 63, and the electrical connector 64 are mounted on the substrate 61. Both end portions of the optical fiber 55 are held by the lens components 53 and 63, respectively.

The substrate 51 is disposed in the monitor unit 2 and is housed in the housing 23. An image signal from the camera 22, for example, is input to the electrical connector 54. The optical element 52 converts an electrical signal into an optical signal. The optical element 52 is, for example, a vertical cavity surface emitting laser (VCSEL), which is a type of semiconductor laser diode. The optical element 52 converts an electrical signal from the camera 22 into an optical signal. The optical signal is focused on the optical fiber 55 by the lens component 53.

The substrate 61 is disposed in the main body portion 3 and is housed in the housing 35. The optical signal from the optical fiber 55 is focused on the optical element 62 by the lens component 63. The optical element 62 converts an optical signal into an electrical signal. The optical element 62 is, for example, a photodiode (PD). The optical element 62 converts the optical signal from the optical fiber 55 into an electrical signal. The electrical signal is output from the electrical connector 64 to the motherboard 34 and processed by a chipset mounted on the motherboard 34.

As shown in FIG. 1, the optical fiber 55 extends from the substrate 51 toward the substrate 61 while bypassing the display 21 in a state where the optical module 5 is housed in the information device 1. The hinge portion 4 is provided with, for example, a hole, and the optical fiber 55 extends from the monitor unit 2 to the main body portion 3 through the hole.

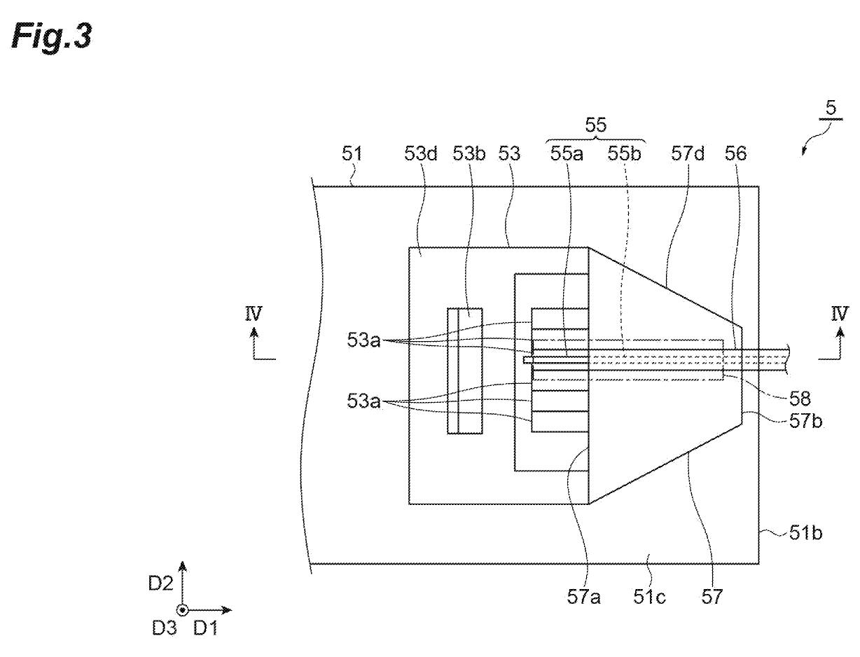

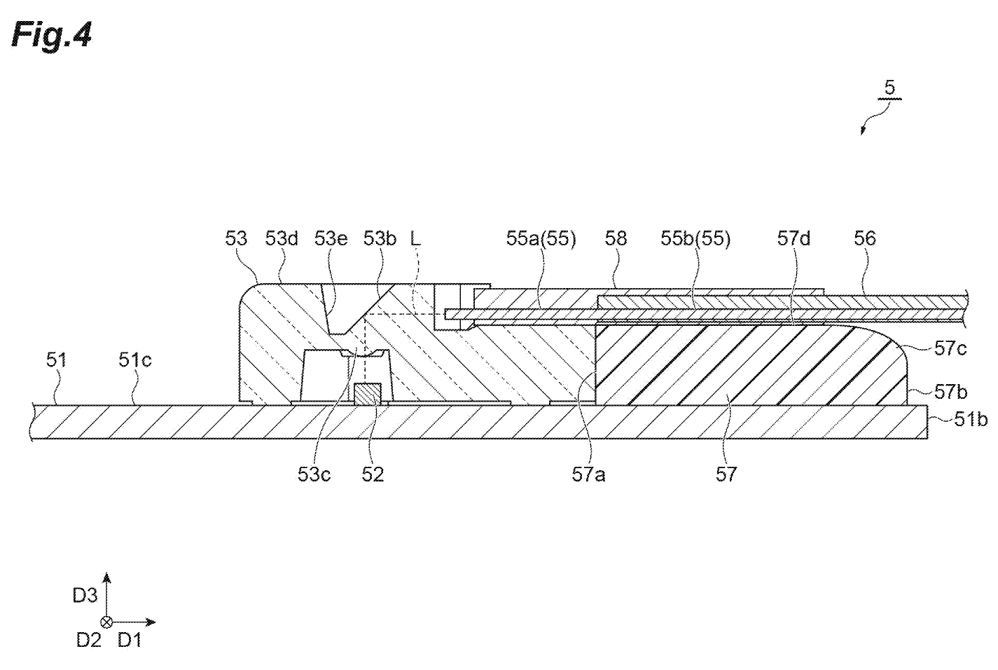

Referring to FIGS. 3 and 4, the optical module 5 will be described in detail. FIG. 3 is a top view showing a part of the optical module 5 shown in FIG. 2 in an enlarged manner. FIG. 4 is a cross-sectional view taken along line IV-IV of FIG. 3. A portion of the optical module 5 disposed in the main body portion 3 has a similar configuration to a portion of the optical module 5 disposed in the monitor unit 2. That is, an arrangement on the substrate 51 is similar to an arrangement on the substrate 61. Thus, in the following description, the arrangement on the substrate 51 will be described in detail, and the description of the arrangement on the substrate 61 may be omitted. In the following description, a direction perpendicular to the direction D1 is referred to as a direction D2 (third direction), and a direction perpendicular to both the direction D1 and the direction D2 is referred to as a direction D3 (second direction).

The optical fiber 55 includes a tip portion 55a and a covered portion 55b continuous from the tip portion 55a. The optical module 5 further includes a covering member 56, and the covering member 56 covers the covered portion 55b such that the tip portion 55a is exposed. The tip portion 55a and the covered portion 55b are formed of, for example, glass fiber. The material of the covering member 56 is, for example, a resin material.

The substrate 51 is formed in a rectangular shape elongated in the direction D1. The substrate 51 has a front end 51a, a rear end 51b, and a main surface 51c (see also FIG. 2). The rear end 51b is located opposite to the front end 51a in the direction D1. The optical element 52 and the lens component 53 are disposed on the main surface 51c near the rear end 51b. The optical element 52 has an optical axis along the direction D3 (a direction perpendicular to the main surface 51c). The lens component 53 is disposed on the main surface 51c so as to cover the optical element 52.

The lens component 53 has an optical path L between the tip portion 55a of the optical fiber 55 and the optical element 52 therein. A region of the lens component 53 including at least the optical path L is formed of a transparent material such as glass or transparent resin through which light can propagate. The transparent resin is, for example, a polyether imide-based resin. The lens component 53 is formed in a rectangular parallelepiped shape, and the entire lens component 53 is made of a light transmissive material.

The lens component 53 includes a plurality of (six in the embodiment) grooves 53a, a mirror portion 53b, and a lens portion 53c. The plurality of grooves 53a are formed in a region near the rear end 51b in a surface 53d of the lens component 53. The tip portion 55a of the optical fiber 55 is placed on one of the plurality of grooves 53a. The plurality of grooves 53a are optical fiber holding portions that hold the tip portions 55a of the optical fibers 55. The lens component 53 may have only one groove 53a.

The mirror portion 53b is optically coupled to the optical fiber 55. The mirror portion 53b bends the optical path L between the tip portion 55a of the optical fiber 55 and the optical element 52 by changing a propagation direction of light. The mirror portion 53b converts the propagation direction of the light propagating in the vertical direction from the optical element 52 into the horizontal direction.

The mirror portion 53b forms a part of the surface of the lens component 53. In the embodiment, the lens component 53 includes a recessed portion 53e formed in the surface 53d, and the mirror portion 53b forms a part of an inner surface of the recessed portion 53e. The recessed portion 53e is recessed toward the substrate 51 from the surface 53d. Among a plurality of inner side surfaces forming the recessed portion 53e, the inner side surface close to the optical fiber 55 is inclined with respect to the optical path L. The mirror portion 53b is formed by the inclined inner side surface. The inner side surface forming the mirror portion 53b reflects light due to a difference in refractive index between the material forming the lens component 53 and air present in the recessed portion 53e.

The lens portion 53c is formed on the optical path L between the tip portion 55a of the optical fiber 55 and the optical element 52. The lens portion 53c is formed in a convex shape on a surface of the lens portion 53c facing the substrate 51. The mirror portion 53b is optically coupled to the optical element 52 via the lens portion 53c.

The optical module 5 further includes a support member 57 (auxiliary member) and an adhesive portion 58.

The support member 57 is disposed between the covering member 56 and the main surface 51c of the substrate 51 and is fixed to the main surface 51c. The support member 57 supports the covering member 56 and the covered portion 55b inside the covering member 56. The support member 57 is disposed on the main surface 51c near the rear end 51b. The support member 57 is disposed relative to the plurality of grooves 53a in the direction D1 (first direction) extending from the tip portion 55a of the optical fiber 55 toward the covered portion 55b. That is, the support member 57 is disposed in a space between the plurality of grooves 53a (lens component 53) and the rear end 51b of the substrate 51. The support member 57 may be in contact with the lens component 53 or may be separated from the lens component 53.

The support member 57 has a front end 57a and a rear end 57b located opposite to the front end 57a in the direction D1. The support member 57 is a plate member formed such that a width of the support member 57 decreases with increasing distance from the plurality of grooves 53a in the direction D1 when viewed from the direction D3. Specifically, the support member 57 is formed in a trapezoidal shape in which a width of the front end 57a in the direction D2 is longer than a width of the rear end 57b in the direction D2. Thus, a region including the rear end 57b of the support member 57 becomes softer than a region including the front end 57a of the support member 57.

The support member 57 includes a corner portion 57c. The corner portion 57c is a corner portion facing the covering member 56 (a corner portion not in contact with the substrate 51) among two corner portions located opposite to the plurality of grooves 53a when viewed in the direction D2. The corner portion 57c forms a part of the rear end 57b. The corner portion 57c is chamfered. In the embodiment, the corner portion 57c has an R-chamfered shape. The corner portion 57c may have a C-chamfered shape.

The support member 57 is formed of a resin material such as polypropylene resin. A Young's modulus of the support member 57 is smaller than a Young's modulus of the optical fiber 55. That is, the support member 57 is softer than the optical fiber 55.

The adhesive portion 58 bonds the tip portion 55a of the optical fiber 55 and the groove 53a to each other and extends from the groove 53a toward the support member 57. Thus, the adhesive portion 58 further bonds the covering member 56 and the support member 57 to each other. Specifically, the adhesive portion 58 bonds the covering member 56 and a surface 57d (a surface located opposite to the main surface 51c of the substrate 51) facing the covering member 56 among the surfaces of the support member 57. The support member 57 can be said to be an additional component for increasing the bonding area of the covering member 56. The adhesive portion 58 is, for example, a cured product of a UV curable resin.

According to the embodiment described above, the covering member 56 covering the optical fiber 55 is bonded to the support member 57 disposed relative to the groove 53a in the direction D1 extending from the tip portion 55a of the optical fiber 55 to the covered portion 55b by the adhesive portion 58. In this manner, the covering member 56 is bonded to the support member 57 in front of the tip portion 55a of the optical fiber 55, so that the influence of an external force (for example, an external force such as bending of the optical fiber 55) acting on the optical fiber 55 on the tip portion 55a of the optical fiber 55 can be reduced. This can prevent, for example, damage or the like to the tip portion 55a of the optical fiber 55 due to the external force acting on the optical fiber 55. Thus, according to the optical module 5, the reliability of the optical fiber 55 can be improved.

In the embodiment, the adhesive portion 58 bonds the tip portion 55a and the groove 53a to each other and extends from the groove 53a toward the support member 57. Thus, the tip portion 55a of the optical fiber 55 can be fixed to the groove 53a, and the covering member 56 can be fixed to the support member 57. Thus, the optical fiber 55 can be stably fixed.

In the embodiment, the support member 57 is disposed between the covering member 56 and the main surface 51c of the substrate 51 and is fixed to the main surface 51c. Thus, the support member 57 can support the covering member 56, and the optical fiber 55 can be stably fixed.

In the embodiment, the support member 57 includes the corner portion 57c located opposite to the groove 53a and facing the covering member 56, and the corner portion 57c is chamfered. For example, when the external force such as bending of the optical fiber 55 occurs, the covering member 56 covering the covered portion 55b of the optical fiber 55 follows the chamfered corner portion 57c, so that the influence on the tip portion 55a of the optical fiber 55 (stress transmitted to the tip portion 55a) can be further reduced. Thus, the reliability of the optical fiber 55 can be further improved.

In the embodiment, the support member 57 is formed such that the width of the support member 57 decreases with increasing distance from the groove 53a in the direction D1 when viewed from the direction D3. In this case, a portion of the support member 57 having a small width (a portion relatively distant from the tip portion 55a of the optical fiber 55) becomes soft. Thus, for example, when the external force such as bending of the optical fiber 55 occurs, the portion having a small width is easily deformed, and as a result, the influence on the tip portion 55a of the optical fiber 55 can be further reduced. Thus, the reliability of the optical fiber 55 can be further improved.

In the embodiment, the Young's modulus of the support member 57 is smaller than the Young's modulus of the optical fiber 55. In this case, the support member 57 becomes relatively soft. As a result, for example, when the external force such as bending of the optical fiber 55 occurs, the support member 57 absorbs the external force, and thus, the influence on the tip portion 55a of the optical fiber 55 (stress transmitted to the tip portion 55a) can be further reduced.

### Modification of first embodiment

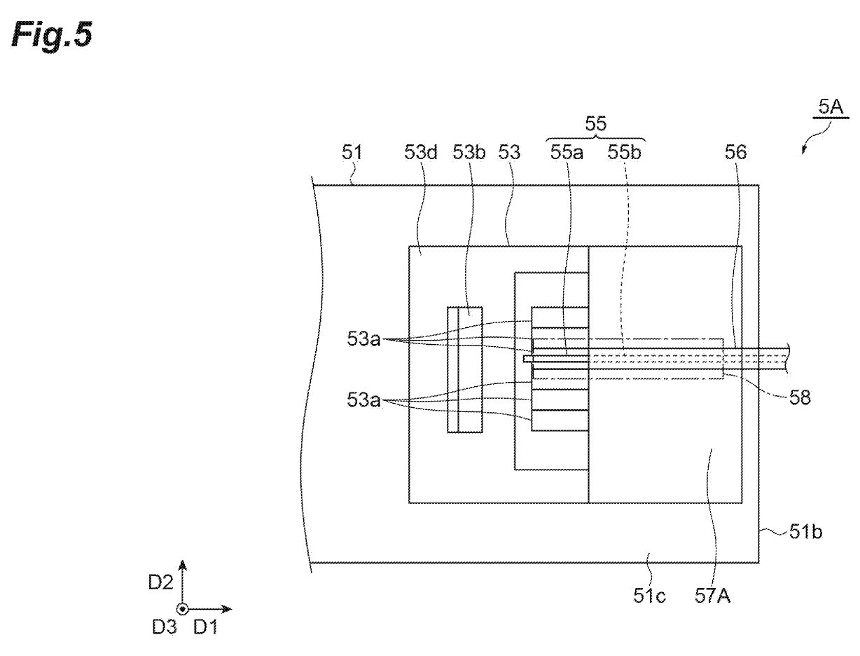

Next, an optical module 5A according to a modification of the first embodiment will be described. FIG. 5 is a top view showing a part of the optical module 5A in an enlarged manner. As shown in FIG. 5, the optical module 5A is different from the optical module 5 in that the optical module 5A includes a support member 57A having a shape different from that of the support member 57 instead of the support member 57 of the first embodiment.

The support member 57A is formed in a rectangular parallelepiped shape. The support member 57A is formed in a rectangular shape when viewed from the direction D3. A corner portion of the support member 57A is not chamfered unlike the corner portion 57c of the support member 57. The optical module 5A described above can also improve the reliability of the optical fiber 55.

### Second embodiment

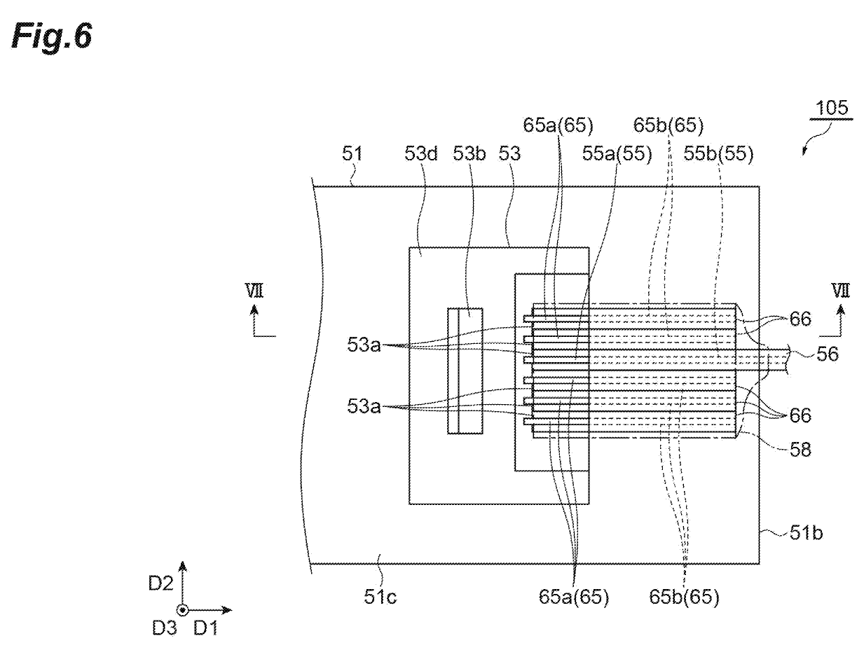

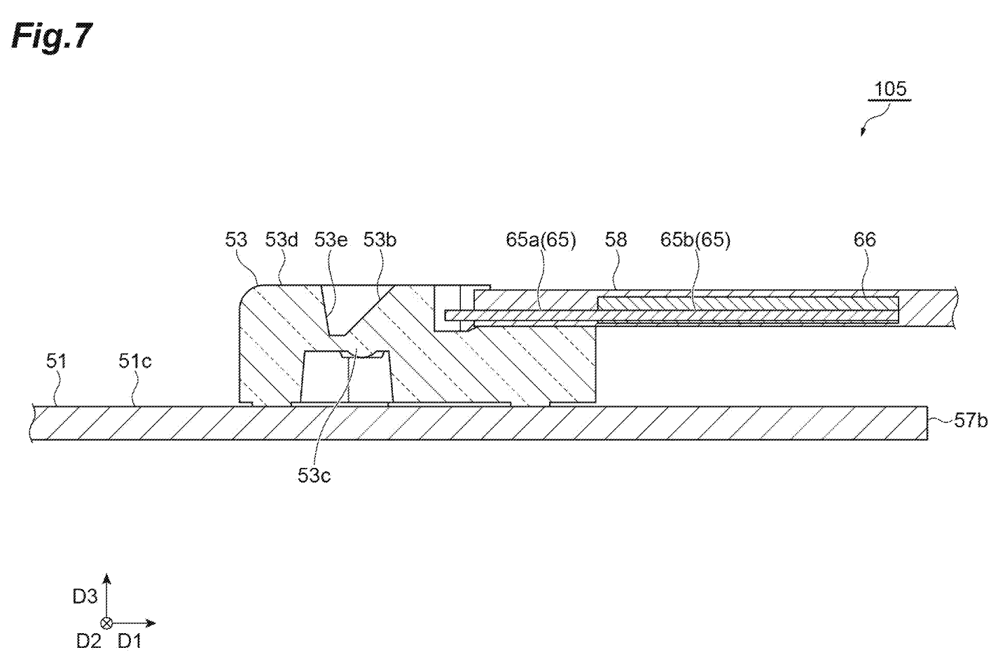

Next, an optical module 105 included in an information device according to a second embodiment will be described. FIG. 6 is a top view showing a part of the optical module 105 in an enlarged manner. FIG. 7 is a cross-sectional view taken along line VII-VII of FIG. 6. The optical module 105 is different from the optical module 5 in that the optical module 105 includes a plurality (five in the embodiment) of dummy optical fibers 65 and a plurality (five in the embodiment) of dummy covering members 66 instead of the support member 57 of the first embodiment.

The dummy optical fiber 65 is formed of, for example, the same material (for example, a glass material) as the optical fiber 55. The dummy optical fiber 65 has a tip portion 65a and a covered portion 65b continuous from the tip portion 65a, and extends along the direction D1. The tip portion 65a of the dummy optical fiber 65 is placed in the groove 53a, in which the tip portion 55a of the optical fiber 55 is not placed, among the plurality of grooves 53a.

The dummy optical fiber 65 does not transmit light. Thus, the tip portion 55a of the optical fiber 55 is optically coupled to the optical element 52, whereas the tip portion 65a of the dummy optical fiber 65 is not optically coupled to the optical element 52. Further, the optical fiber 55 extends outside the substrate 51 to transmit light, whereas the entire dummy optical fiber 65 is located inside an outer edge of the substrate 51 when viewed from the direction D3. An end portion of the optical fiber 55 opposite to the tip portion 55a is optically coupled to another optical component, whereas an end portion of the dummy optical fiber 65 opposite to the tip portion 65a is not optically coupled to another optical component.

The dummy covering member 66 is formed of, for example, the same material (for example, a resin material) as the covering member 56. The dummy covering member 66 covers the covered portion 65b so that the tip portion 65a is exposed. The entire dummy covering member 66 is located inside the outer edge of the substrate 51 when viewed from the direction D3, similarly to the dummy optical fiber 65.

A plurality of sets each consisting of the dummy optical fiber 65 and the dummy covering member 66 are arranged in the direction D2 together with a set of the optical fiber 55 and the covering member 56. Specifically, the set of the optical fiber 55 and the covering member 56 is sandwiched between two sets each consisting of the dummy optical fibers 65 and the dummy covering members 66 in the direction D2. In this manner, the dummy covering members 66 are arranged with the covering member 56 in the direction D2.

The adhesive portion 58 bonds the tip portion 55a of the optical fiber 55 and the groove 53a to each other, and bonds the tip portion 65a of the dummy optical fiber 65 and the groove 53a to each other. Further, the adhesive portion 58 bonds the covering member 56 and the dummy covering member 66 adjacent to each other, and bonds two adjacent dummy covering members 66 to each other.

The optical module 105 described above can also improve the reliability of the optical fiber 55. In addition, since the dummy covering members 66 are arranged with the covering member 56 in the direction D2, the bending of the optical fiber 55 in the direction D2 can be effectively prevented.

In the optical module 105, the additional component for increasing the bonding area of the covering member 56 includes the dummy optical fiber 65 and the dummy covering member 66, the tip portion 65a of the dummy optical fiber 65 is held in the groove 53a, and the adhesive portion 58 bonds the covering member 56 and the dummy covering member 66 to each other. In this case, the bonding area of the covering member 56 can be increased while the dummy optical fiber 65 and the dummy covering member 66 are disposed using the groove 53a.

### Third embodiment

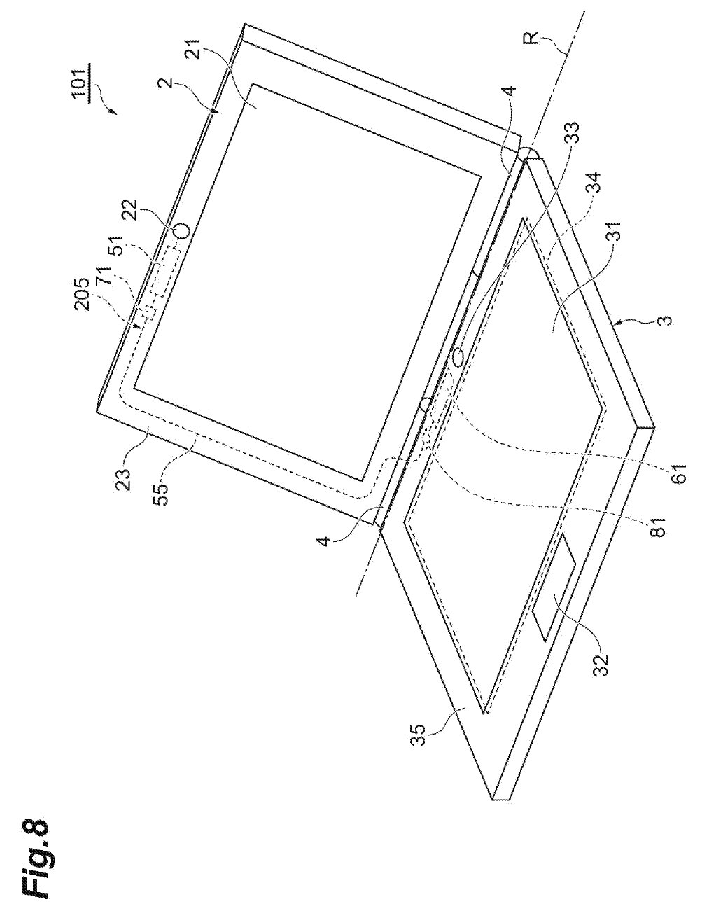

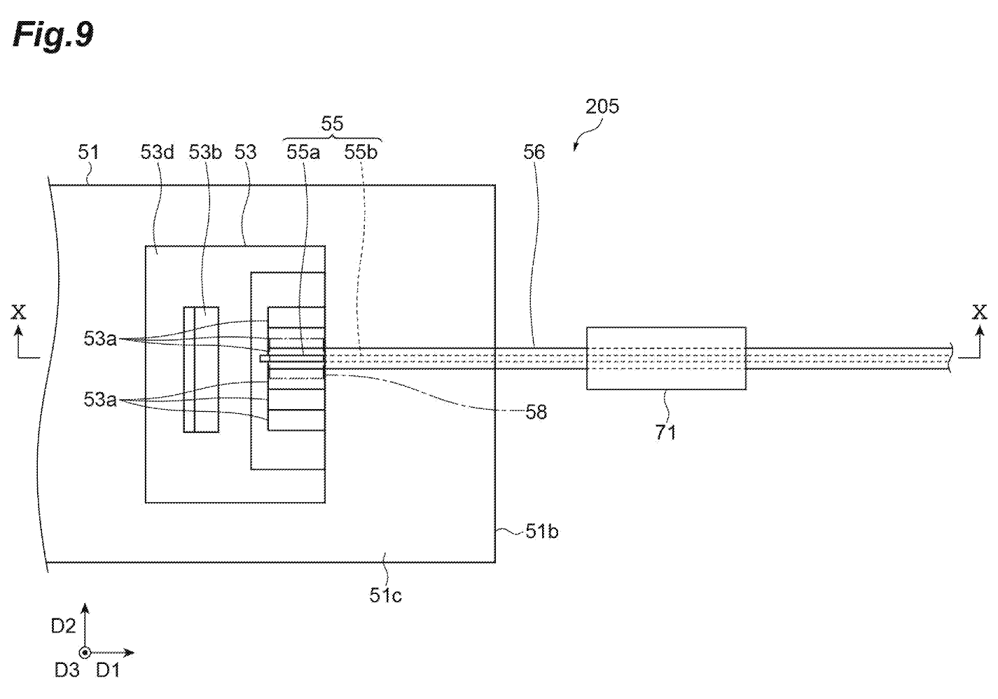

Next, an information device 101 according to a third embodiment will be described. FIG. 8 is a perspective view showing an example of the information device 101 according to the third embodiment. FIG. 9 is a top view showing a part of an optical module included in the information device 101 in an enlarged manner. The information device 101 includes an optical module 205 instead of the optical module 5 of the first embodiment. The optical module 205 is different from the optical module 5 in that the optical module 205 does not include the support member 57. The information device 101 further includes fixing portions 71 and 81. A configuration of the fixing portion 81 is similar to a configuration of the fixing portion 71. Thus, in the following description, the description of the configuration of the fixing portion 81 may be omitted.

The fixing portion 71 is disposed in the monitor unit 2 and is housed in the housing 23. The fixing portion 71 is fixed to the housing 23 relative to the substrate 51 in the direction D1 extending from the tip portion 55a of the optical fiber 55 to the covered portion 55b. The fixing portion 71 is fixed to the housing 23 with, for example, a screw or an adhesive. The fixing portion 71 may be integrally formed with the housing 23. The fixing portion 71 is separated from the rear end 51b of the substrate 51 in the direction D1. A distance between the fixing portion 71 and the rear end 51b of the substrate 51 is, for example, 400 mm or less. The distance may be 200 mm or less, 100 mm or less, 50 mm or less, or 10 mm or less.

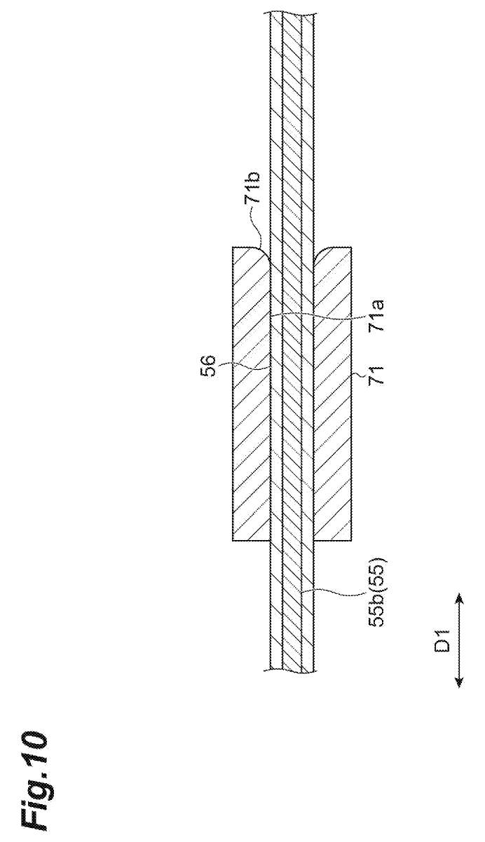

FIG. 10 is a cross-sectional view taken along line X-X of FIG. 9. The fixing portion 71 has a through hole 71a into which the optical fiber 55 and the covering member 56 are inserted. The fixing portion 71 holds the optical fiber 55 as the optical fiber 55 passes through the through hole 71a. The through hole 71a extends through the fixing portion 71 along the direction D1. The through hole 71a has an edge portion 71b that is open opposite to the substrate 51. The edge portion 71b is curved in a convex manner such that a width of the through hole 71a increases toward the outside of the through hole 71a. In other words, the edge portion 71b has an R-chamfered shape.

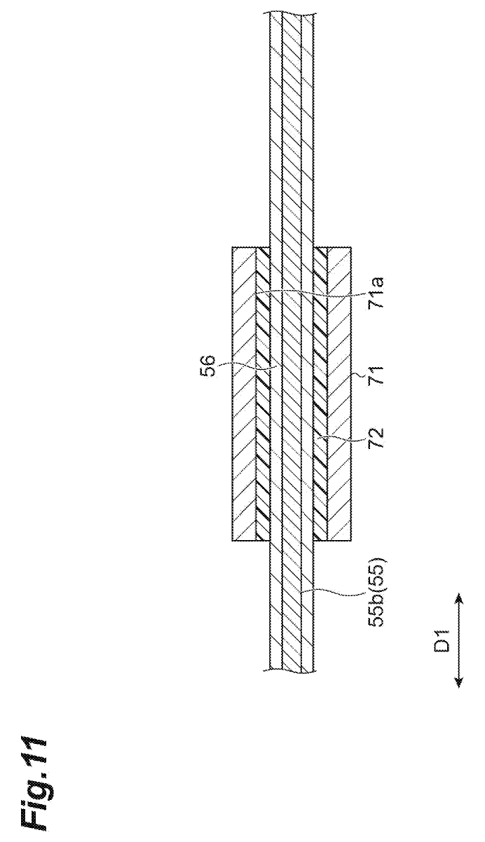

The through hole 71a of the fixing portion 71 may be filled with an adhesive portion 72 (second adhesive portion). FIG. 11 is a cross-sectional view showing a state in which the through hole 71a of the fixing portion 71 is filled with the adhesive portion 72. In this case, the through hole 71a has a shape larger than the covering member 56 by the amount of the adhesive portion 72 filled therein. The adhesive portion 72 bonds the covering member 56 and the inner surface of the through hole 71a to each other. The adhesive portion 72 is a cured product of an adhesive having elasticity even after curing. That is, the adhesive portion 72 is also an elastic member. The adhesive portion 72 is, for example, a cured product of a UV curable resin. A bonding strength of the adhesive portion 72 between the fixing portion 71 and the covering member 56 is greater than a bonding strength of the adhesive portion 58 between the tip portion 55a of the optical fiber 55 and the groove 53a.

The fixing portion 81 is disposed in the main body portion 3 and is housed in the housing 35. The fixing portion 81 is disposed away from the substrate 61 and fixed to the housing 35. The fixing portion 81 has a through hole (not shown) into which the optical fiber 55 and the covering member 56 are inserted, similarly to the fixing portion 71.

The optical module 205 may include a plurality of optical fibers 55, and the plurality of optical fibers 55 may pass through the through hole 71a.

According to the third embodiment described above, the optical fiber 55 is held by the fixing portion 71 fixed to the housing 23 in the direction D1 with respect to the substrate 51. In this manner, the optical fiber 55 is held by the fixing portion 71 in front of the tip portion 55a of the optical fiber 55, so that the influence of an external force (for example, an external force such as bending of the optical fiber 55) acting on the optical fiber 55 on the tip portion 55a of the optical fiber 55 can be reduced. This can prevent, for example, damage or the like to the tip portion 55a of the optical fiber 55 due to the external force acting on the optical fiber 55. Thus, according to the information device 101, the reliability of the optical fiber 55 can be improved.

In the third embodiment, a distance between the fixing portion 71 and the substrate 51 may be, for example, 400 mm or less. In this case, the optical fiber 55 can be stably held.

In the third embodiment, the edge portion 71b of the through hole 71a is curved in a convex manner such that the width of the through hole 71a increases. For example, when the external force such as bending of the optical fiber 55 occurs, the optical fiber 55 follows the edge portion 71b, so that the influence on the tip portion 55a of the optical fiber 55 (stress transmitted to the tip portion 55a) can be further reduced.

In the third embodiment, the adhesive portion 72 may be disposed between the covering member 56 and the through hole 71a. For example, when the external force such as bending of the optical fiber 55 occurs, the adhesive portion 72 absorbs the external force, and thus, the influence on the tip portion 55a of the optical fiber 55 (stress transmitted to the tip portion 55a) can be further reduced.

In the third embodiment, the bonding strength of the adhesive portion 72 between the fixing portion 71 and the covering member 56 is greater than the bonding strength of the adhesive portion 58 between the tip portion 55a of the optical fiber 55 and the groove 53a. This can improve the tensile strength of the optical fiber 55.

### Fourth embodiment

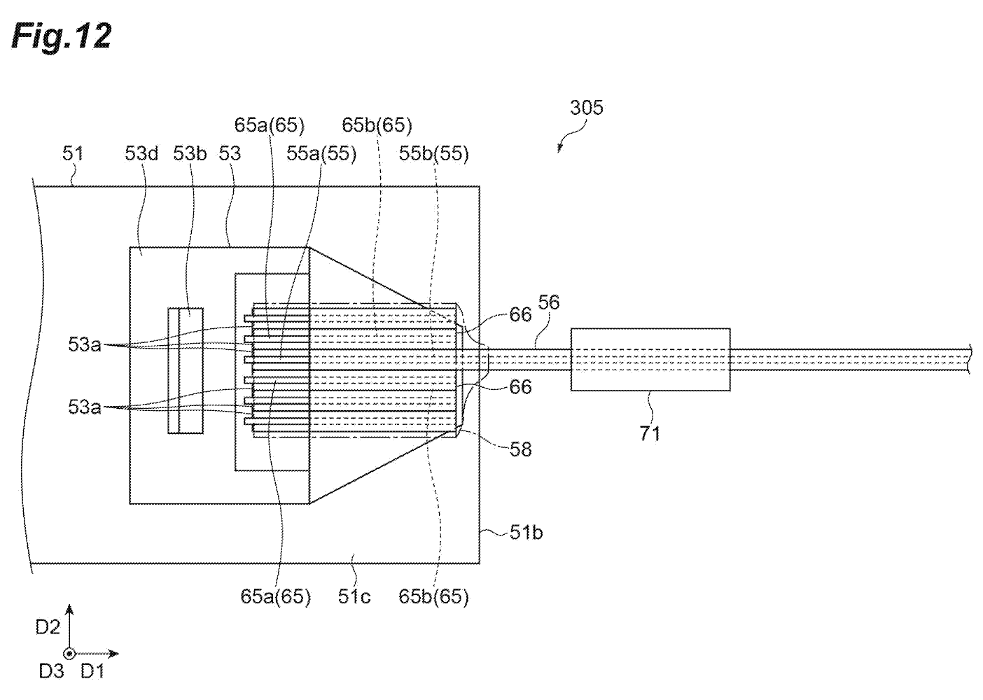

Next, an information device according to a fourth embodiment will be described. FIG. 12 is a top view showing a part of an optical module 305 included in an information device according to the fourth embodiment in an enlarged manner. The information device according to the fourth embodiment includes the optical module 305 instead of the optical module 205 of the third embodiment.

The optical module 305 is different from the optical module 205 of the third embodiment in that the optical module 305 includes the support member 57 of the first embodiment, the plurality of dummy optical fibers 65 of the second embodiment, and the plurality of dummy covering members 66 of the second embodiment. The adhesive portion 58 bonds the covering member 56 and the support member 57 (first auxiliary member) to each other, and bonds the covering member 56 and the dummy covering member 66 (second auxiliary member) to each other. The fixing portion 71 is disposed away from the rear end 51b of the substrate 51 in the direction D1, similarly to the third embodiment.

The fourth embodiment described above can also improve the reliability of the optical fiber 55. In addition, the optical fiber 55 can be more stably fixed by increasing the bonding area of the covering member 56 by the support member 57 and the dummy covering member 66 and holding the optical fiber 55 by the fixing portion 71. Thus, when the external force such as bending of the optical fiber 55 occurs, the influence on the tip portion 55a of the optical fiber 55 (stress transmitted to the tip portion 55a) can be further reduced.

### Modification

The optical module and the information device according to the present disclosure are not limited to the above-described embodiments and modifications, and various other modifications are possible.

In the second embodiment, the plurality of sets each consisting of the dummy optical fiber 65 and the dummy covering member 66 are arranged in the direction D2 together with the set of the optical fiber 55 and the covering member 56, but a member other than the dummy optical fiber 65 and the dummy covering member 66 may be arranged in the direction D2 together with the covering member 56. In this case, the adhesive portion 58 bonds the covering member 56 and the member to each other.

In the third embodiment, the adhesive portion 72 is filled between the covering member 56 and the inner surface of the through hole 71a, but an elastic member (for example, a rubber member or the like) having no adhesive capability may be disposed between the covering member 56 and the inner surface of the through hole 71a. In this case, when an external force such as bending of the optical fiber 55 occurs, the elastic member can absorb the external force.

In the third embodiment, the optical fiber 55 is inserted through the through hole 71a of the fixing portion 71 in a state of being covered with the covering member 56, but the optical fiber 55 may be inserted through the through hole 71a of the fixing portion 71 in a state of not being covered with the covering member 56. That is, the optical fiber 55 may be directly held by the fixing portion 71. In this case, the adhesive portion 72 bonds the optical fiber 55 and the inner surface of the through hole 71a to each other.

In the fourth embodiment, the support member 57 may be omitted. Alternatively, the plurality of dummy optical fibers 65 and the plurality of dummy covering members 66 may be omitted. Alternatively, the fixing portion 71 may be omitted.

What is claimed is:

1. An optical module comprising:
a substrate including a main surface;
an optical element disposed on the main surface;
a lens component disposed on the main surface;
an optical fiber including a tip portion and a covered portion continuous from the tip portion;
a covering member that covers the covered portion such that the tip portion is exposed;
an auxiliary member; and
an adhesive portion,
wherein the lens component includes an optical fiber holding portion that holds the tip portion, and a lens portion disposed on an optical path between the optical element and the tip portion of the optical fiber,
wherein the auxiliary member is disposed relative to the optical fiber holding portion in a first direction, the first direction extending from the tip portion of the optical fiber toward the covered portion of the optical fiber, and
wherein the adhesive portion bonds the covering member and the auxiliary member to each other.

2. The optical module according to claim 1,
wherein the adhesive portion bonds the tip portion and the optical fiber holding portion to each other and extends from the optical fiber holding portion toward the auxiliary member.

3. The optical module according to claim 1,
wherein the auxiliary member is disposed between the covering member and the main surface and fixed to the main surface.

4. The optical module according to claim 3,
wherein the auxiliary member includes a corner portion located opposite to the optical fiber holding portion, the corner portion and the covering member facing each other, and
wherein the corner portion is chamfered.

5. The optical module according to claim 3,
wherein, when viewed from a second direction intersecting the main surface, the auxiliary member is formed such that a width of the auxiliary member decreases with increasing distance from the optical fiber holding portion in the first direction.

6. The optical module according to claim 3,
wherein a Young's modulus of the auxiliary member is smaller than a Young's modulus of the optical fiber.

7. The optical module according to claim 1,
wherein the auxiliary member is disposed alongside the covering member in a third direction, the third direction intersecting the first direction and extending along the main surface.

8. The optical module according to claim 7,
wherein the auxiliary member includes a dummy optical fiber configured not to transmit light and a dummy covering member that covers the dummy optical fiber,
wherein a tip portion of the dummy optical fiber is held by the optical fiber holding portion, and
wherein the adhesive portion bonds the covering member and the dummy covering member to each other.

9. The optical module according to claim 1,
wherein the auxiliary member includes
a first auxiliary member disposed between the covering member and the main surface and fixed to the main surface, and
a second auxiliary member disposed alongside the covering member in a third direction, the third direction intersecting the first direction and extending along the main surface, and
wherein the adhesive portion bonds the covering member and the first auxiliary member to each other and bonds the covering member and the second auxiliary member to each other.

10. An information device comprising:
the optical module according to claim 1; and
a housing that houses the optical module.

11. An information device comprising:
an optical module;
a fixing portion; and
a housing that houses the optical module and the fixing portion,
wherein the optical module includes
a substrate including a main surface,
an optical element disposed on the main surface,
a lens component disposed on the main surface, and
at least one optical fiber including a tip portion and a covered portion continuous from the tip portion,
wherein the lens component includes an optical fiber holding portion that holds the tip portion, and a lens portion disposed on an optical path between the optical element and the tip portion of the optical fiber, and
wherein the fixing portion is fixed to the housing relative to the substrate in a first direction, the first direction extending from the tip portion of the optical fiber toward the covered portion of the optical fiber, and holds the optical fiber.

12. The information device according to claim 11,
wherein the fixing portion has a through hole into which the at least one optical fiber or a plurality of the optical fibers is inserted,
wherein the through hole has an edge portion open opposite to the substrate, and
wherein the edge portion is curved in a convex manner such that a width of the through hole increases.

13. The information device according to claim 11, further comprising:
an elastic member,
wherein the fixing portion has a through hole into which the at least one optical fiber is inserted, and
wherein the elastic member is disposed between the optical fiber and the through hole.

14. The information device according to claim 11, further comprising:
a first adhesive portion and a second adhesive portion,
wherein the optical module further includes a covering member that covers the covered portion such that the tip portion is exposed,
wherein the first adhesive portion bonds the tip portion and the optical fiber holding portion to each other,
wherein the second adhesive portion bonds the fixing portion and the covering member to each other, and
wherein a bonding strength between the fixing portion and the covering member is greater than a bonding strength between the tip portion and the optical fiber holding portion.

15. The information device according to claim 11,
wherein the optical module further includes
a covering member that covers the covered portion such that the tip portion is exposed,
an auxiliary member, and
an adhesive portion,
wherein the auxiliary member includes at least one of
a first auxiliary member disposed between the covering member and the main surface and fixed to the main surface, and
a second auxiliary member disposed alongside the covering member in a third direction, the third direction intersecting the first direction and extending along the main surface, and
wherein the adhesive portion bonds the covering member and at least one of the first auxiliary member and the second auxiliary member to each other.
